(19) United States
(12) Patent Application Publication
(10) Pub. No.: US 2018/0319253 A1
(43) Pub. Date: Nov. 8, 2018

(54) VEHICLE VENT ASSEMBLY WITH NOISE DAMPING FLAP

(71) Applicant: GM GLOBAL TECHNOLOGY OPERATIONS LLC, Detroit, MI (US)

(72) Inventors: ALEJANDRO CHAVEZ MARTINEZ, TOLUCA (MX); ALBERTO NAIM KARAM MARROQUIN, TOLUCA (MX)

(73) Assignee: GM GLOBAL TECHNOLOGY OPERATIONS LLC, Detroit, MI (US)

(21) Appl. No.: 15/584,204

(22) Filed: May 2, 2017

(51) Int. Cl. B60H 1/24

(52) U.S. Cl. CPC B60H 1/249; B60H 1/24; B60H 1/248

(57) ABSTRACT

Vent assemblies for opening and closing an interior space of a vehicle, and vehicles including such vent assemblies are provided. An exemplary vent assembly opens and closes an interior space of a vehicle to permit air within the interior space of the vehicle to exit the interior space of the vehicle. The vent assembly includes a structural panel bounding the interior space of the vehicle. The structural panel defines an aperture adapted to provide fluid communication between the interior space and a fluid path. The vent assembly further includes a noise damping flap configured to cover the aperture in a closed position and movable to an open position permitting fluid flow through the aperture. Also, the vent assembly includes a pressure relief valve located at an end of the fluid path and configured for selectively opening and closing fluid communication between the fluid path and an exterior environment outside the vehicle.

The present disclosure generally relates to vent assemblies for pressure relief valves in vehicles, and more particularly relates to noise damping of such vent assemblies.

Am automotive vehicles includes a body defining an interior space, for example a cabin space or a trunk space. The interior space may be closed by a hatch, such as a door, window, gate or trunk lid. The hatch and/or the body include seals to tightly seal the closure of the hatch against the body to prevent debris, water and/or noise from entering the interior space of the vehicle from around a periphery of the closure. These seals also prevent air from escaping as the hatch is closed, thereby causing an increase in air pressure within the interior space of the vehicle. The increased air pressure within the interior space resists the closing of the hatch, thereby increasing the effort required to close the hatch.

In order to alleviate the buildup of air pressure within the interior space of the vehicle when closing the hatch, a vehicle may be equipped with an aperture and a pressure relief valve located in the aperture. The pressure relief valve may open in response to increased air pressure within the interior space of the vehicle to allow air within the interior space to escape, thereby reducing the air pressure within the interior space of the vehicle and reducing the effort to close the hatch.

Further, a vehicle may use a pressure relief valve to influence air flow from the vehicle cabin to enhance passenger comfort. As a climate control system takes in ambient air from outside the vehicle and introduces the air to the vehicle cabin, air exhaustion through the pressure relief valve may be required to attain proper circulation and reduce cabin pressure build-up.

When a pressure relief valve is opened, noise from the exterior of the vehicle may enter through the aperture. To reduce the amount of noise and exterior elements from entering the cabin, pressure relief valves may be designed as small as possible which limits the rate at which the pressure relief valve may equalize pressure.

Accordingly, it is desirable to provide a vent assembly for opening and closing an interior space of a vehicle to permit air within the interior space of the vehicle to exit the interior space of the vehicle. In addition, it is desirable to provide such a vent assembly with an additional noise damping flap to reduce noise from entering the vehicle cabin. Furthermore, other desirable features and characteristics will become apparent from the subsequent detailed description and the appended claims, taken in conjunction with the accompanying drawings and the introduction.

### SUMMARY

Vent assemblies for opening and closing an interior space of a vehicle, and vehicles including such vent assemblies are provided. An exemplary vent assembly opens and closes an interior space of a vehicle to permit air within the interior space of the vehicle to exit the interior space of the vehicle. The vent assembly includes a structural panel bounding the interior space of the vehicle. The structural panel defines an aperture adapted to provide fluid communication between the interior space and a fluid path. The vent assembly further includes a noise damping flap configured to cover the aperture in a closed position and movable to an open position permitting fluid flow through the aperture. Also, the vent assembly includes a pressure relief valve located at an end of the fluid path and configured for selectively opening and closing fluid communication between the fluid path and an exterior environment outside the vehicle.

Another embodiment vent assembly for opening and closing an interior space of a vehicle to permit air within the interior space of the vehicle to exit the interior space of the vehicle includes a structural panel bounding the interior space of the vehicle. The structural panel defines an aperture adapted to provide fluid communication between the interior space and a fluid path. The vent assembly also includes a noise damping flap configured to cover the aperture in a closed position, movable to an intermediate position permitting a first rate of fluid flow through the aperture when air pressure within the interior space is at a first elevated level, and movable to an open position permitting a second rate of fluid flow through the aperture when air pressure within the interior space is at a second elevated level greater than the first elevated level, wherein the second rate of fluid flow is greater than the first rate of fluid flow.

An exemplary vehicle includes an interior cabin bounding by structural panels and having an opening. The vehicle also includes a hatch configured to close the opening. The vehicle further includes an aperture configured to allow airflow to exit the interior cabin during closure of the hatch. Also, the vehicle includes a vent assembly for opening and closing the interior space of a vehicle to permit air within the interior space of the vehicle to exit the interior space of the vehicle. The vent assembly includes a noise damping flap configured to cover the aperture in a closed position and movable to an open position permitting fluid flow through the aperture. The vent assembly further includes a pressure relief valve located at an end of the fluid path and configured for selectively opening and closing fluid communication between the fluid path and an exterior environment outside the vehicle.

### BRIEF DESCRIPTION OF THE DRAWINGS

The present subject matter will hereinafter be described in conjunction with the following drawing figures, wherein like numerals denote like elements, and wherein:

FIG. 1 is a perspective view of a portion of a vehicle including a vent assembly in accordance with an embodiment herein;

FIG. 2 is a schematic view of the vent assembly of FIG. 1 in accordance with an embodiment herein;

FIGS. 3-5 are front views of embodiments of the flap from the vent assembly of FIG. 2;

FIGS. 6-8 are cross sectional views of the embodiments of the flaps of FIGS. 3-5, respectively;

FIGS. 9-11 are cross sectional views of an exemplary flap mounted to a vehicle panel, illustrating movement of the flap between closed and open positions; and

FIG. 12 is a perspective view of a pressure relief valve from the vent assembly of FIG. 2 in accordance with an embodiment herein.

### DETAILED DESCRIPTION

The following detailed description is merely exemplary in nature and is not intended to limit the subject matter claimed herein. Furthermore, there is no intention to be bound by any theory presented in the preceding background or the following detailed description.

Embodiments provided herein allow for air flow out of a vehicle cabin through an aperture when the air pressure within the cabin is higher than the air pressure of the space surrounding the vehicle. For example, air flow out of the cabin may occur when an opening of the vehicle is closed with a hatch, i.e., during the closure of the hatch. During closure of the hatch, air pressure within the cabin may rise significantly, and air flow out of the aperture may be at a high flow rate. Also, air flow out of the cabin may occur when air conditioned or heated air is introduced into the cabin, such as be an HVAC system. Due to the introduction of air into the cabin by the HVAC system, air pressure within the cabin may rise slightly, and air flow out of the aperture may be at a reduced flow rate, as compared to the high flow rate during hatch closure. In either case, a pressure relief valve may open to allow the air flow out of the cabin.

As described herein, a noise damping flap is provided to reduce noise entering the cabin when the pressure relief valve is opened. The flap allows for air flow out of the cabin at the high flow rate and at the reduced flow rate, as the flap is passively moved from a closed position to an open or a slightly open position by the flow of air out of the cabin. The flap automatically closes when the air flow stops. As a result, the flap may provide acoustic insulation to the cabin.

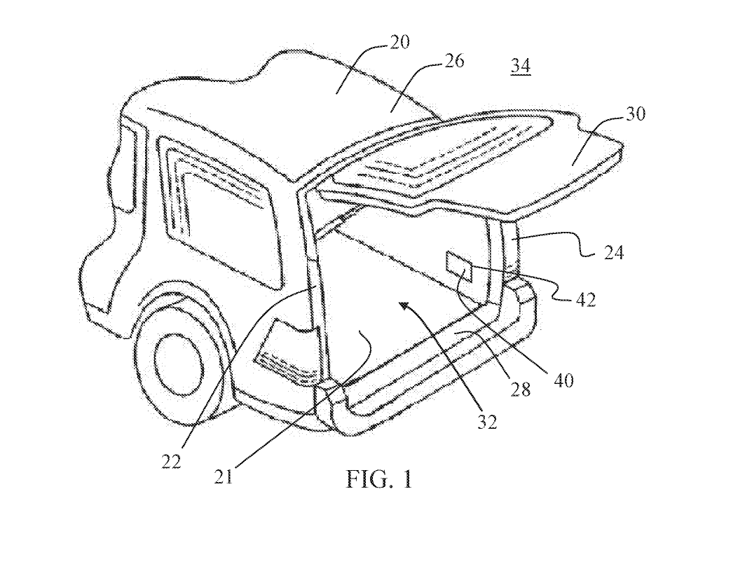

FIG. 1 is a perspective view of an exemplary vehicle 20. The vehicle 20 includes at least one opening 21 surrounded by a vehicle structural panel or panels 22, such as walls 24, roof 26, and floor 28. The vehicle 20 further includes a hatch 30, i.e., a door, gate, trunk lid, window, or the like, for selectively closing the opening 21. In FIG. 1, the hatch 30 is opened to reveal an interior space or cabin 32 of the vehicle 20. The hatch 30 may be closed to isolate the interior space 32 from the external environment or atmosphere 34, i.e., exterior space 34, surrounding the vehicle 20.

As shown in FIG. 1, the vehicle 20 is further provided with a vent assembly 40 for permitting air within the interior space 32 of the vehicle 20 to exit the interior space 32 of the vehicle 20 during periods of increased air pressure, such as when a hatch 30 is shut (and all other hatches 30 are previously shut) or when an airflow is directed into the interior space 32 of the vehicle 20 by an air conditioning or heating unit when all hatches 30 are shut. The vehicle 20 is formed with an aperture 42 formed through a structural panel 22, such as wall 24. The vent assembly 40 is provided to open and close fluid communication through the aperture 42. While FIG. 1 depicts the vent assembly 40 and aperture 42 in wall 24 at a rear portion of vehicle 20, the vent assembly 40 and aperture 42 may be located at any suitable location in the vehicle 20 to provide fluid communication between the interior space 32 and exterior space 34.

FIG. 2 provides a schematic view of the vehicle 20 and vent assembly 40 of FIG. 1. In FIG. 2 and as described above, the vehicle 20 includes an opening 21 that is closed by a hatch 30. The opening 21 extends through structural panel 22 and through external panel 44. In certain locations, the structural panel 22 and external panel 44 may be integral or unitary, i.e., formed from a same or common element, or may be distinct elements in direct contact with one another. In other locations, the structural panel 22 and external panel 44 may be separated from one another. For example, in FIG. 2, an intermediate space or flow path 33 is defined between the structural panel 22 and the external panel 44.

As shown in FIG. 2, the vehicle 20 is provided with an aperture 42 through structural panel 22. Aperture 42 provides fluid communication between the interior space 32 and the intermediate space 33. Further, the vehicle 20 is provided with an aperture 48 through external panel 44. Aperture 48 provides fluid communication between the intermediate space 33 and the exterior space 34.

Together, apertures 42 and 48 may provide fluid communication between the interior space 32 and the exterior space 34. For example, as shown in FIG. 2, the vent assembly 40 is provided to allow for airflow in the direction of arrows 51, 52 and 53, from the interior space 32, through aperture 42, through intermediate space 33, through aperture 48, and into the exterior space 34. As shown, the vent assembly 40 includes a flap 60 in or adjacent aperture 42 and a valve 80 in or adjacent aperture 48 to selectively allow or block airflow through aperture 42 and aperture 48, respectively, in the direction of arrows 51, 52 and 53.

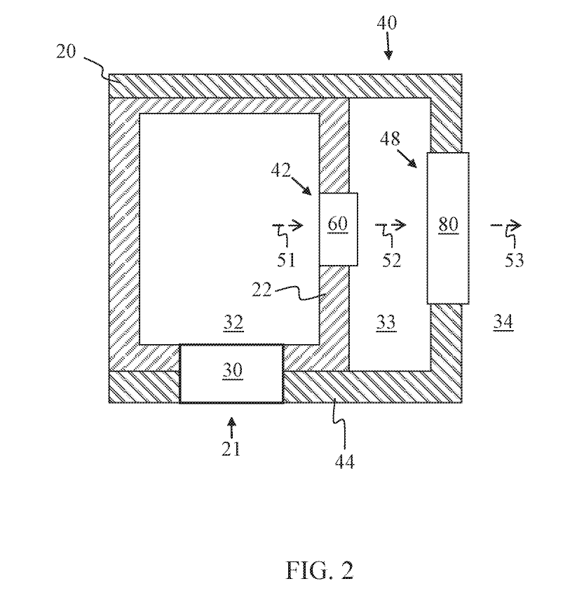

FIGS. 3-8 illustrate the structure of embodiments of the flap 60 of the vent assembly 40. FIGS. 3 and 6 illustrate an embodiment in which the flap 60 is rectangular, with four linear edges. As shown, the flap 60 has a planar top end 61 and a planar bottom end 62 parallel to the top end 61, a planar first side 63 and a planar second side 64 parallel to the first side 63, and a planar front surface 65 and a planar rear surface 66 parallel to the front surface 65. The flap 60 includes a boundary 67 delineating an upper portion 68 adjacent the top end 61 where the flap 60 may be adhered to a structure panel of the vehicle 20.

In the embodiment of FIGS. 3 and 6, the flap 60 is formed from a single material layer 71. For example, the flap 60 may be formed from a noise damping material layer 71. An exemplary noise damping material layer 71 is a fabric or a non-woven fiber. For example, noise damping material layer 71 may be a synthetic fiber, such as thermoplastic polymer resin fiber, for example, polyethylene terephthalate (PET) fiber. An exemplary noise damping material layer 71 may comprises any suitable material sufficient for damping noise. Further, such material may be light, durable, hypoallergenic, and/or non-odor forming. Examples of such materials are sold by Minnesota Mining and Manufacturing Co. (3M), of St. Paul, Minn., under the trademark THINSULATE.

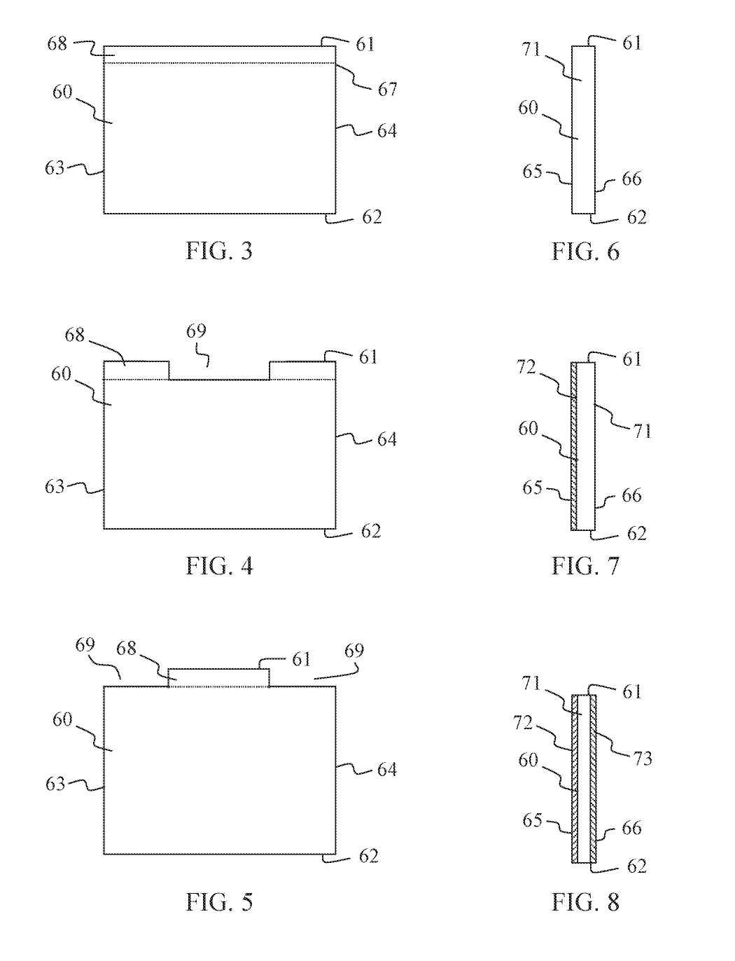

FIGS. 4 and 7 illustrate an embodiment of flap 60 in which the top end 61 of the flap 60 is provided with a centrally positioned notch 69. As a result, the upper portion 68 of the flap 60 may be considered to be formed from extended portions 68 that extend from the rest of the flap 60. Extended portions 68 may be adhered to a structure panel of the vehicle 20.

Further, as shown in FIG. 7, exemplary flap 60 includes material layer 71, as described above, and a material layer 72. Material layer 72 may be a barrier material such as vinyl or a scrim material. Scrim is a lightweight woven textile or screen that may be used to provide backing to the material layer 71. Material layer 71 may be adhered, connected, or otherwise bonded to material layer 72.

FIGS. 5 and 8 illustrate an embodiment of flap 60 in which the top end 61 of the flap 60 is provided with lateral notches 69. As a result, the upper portion 68 of the flap 60 may be considered to be formed by a central extended portion 68 that extends from the rest of the flap 60. Extended portion 68 may be adhered to a structure panel of the vehicle 20.

Further, as shown in FIG. 8, exemplary flap 60 includes material layer 71 and material layer 72, as described above, and a material layer 73. Material layer 73 may be a barrier material such as vinyl or a scrim material. Material layer 73 may be the same material as material layer 72, or may be a different material. Material layer 71 may be adhered, connected, or otherwise bonded to material layer 73.

While FIGS. 3-5 illustrate flaps 60 having differently shaped peripheries, i.e., non-notched, centrally notched or laterally notched, and FIGS. 6-8 illustrate flaps 60 having different numbers of layers, an exemplary flap 60 may be formed from any combination thereof

FIGS. 9-11 illustrate an exemplary flap 60 mounted to a vehicle structural panel 22. As shown, the top portion 68 of the flap 60 is adhered to the vehicle structural panel 22 adjacent the aperture 42. The flap 60 is configured to cover the aperture 42 when in a closed position 77 as shown in FIG. 9. Specifically, the top end 61 and bottom end 62 extend beyond the upper and lower boundaries of the aperture 42. While the top end 61 is always in contact with the vehicle structural panel 22, the bottom end 62 of the flap 60 extends below the aperture 42 and also contacts the vehicle structural panel 22 when the flap 60 is in the closed position 77. Likewise, while not shown, the flap 60 is wider (in the lateral direction between sides 63 and 64) than the aperture 42 such that the sides 63 and 64 also contact the vehicle structural panel 22 when the flap 60 is in the closed position 77.

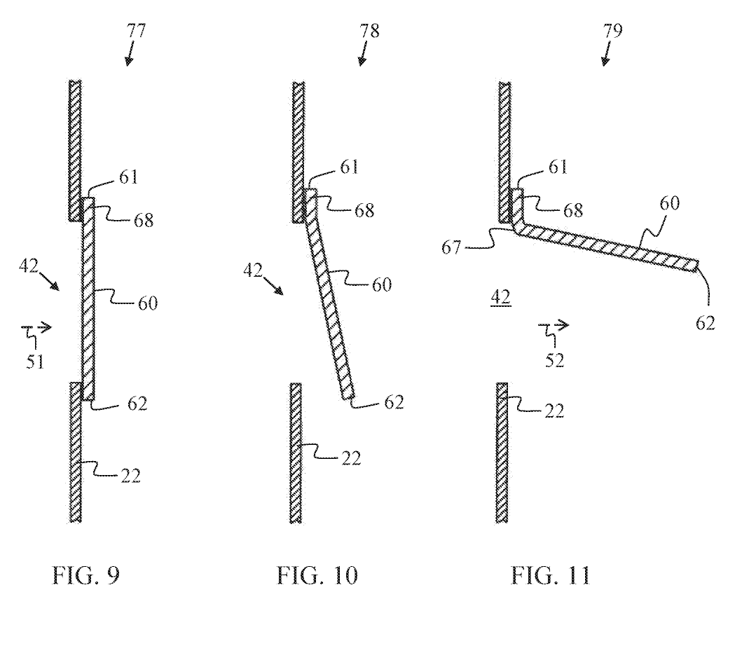

The flap 60 passively moves from the closed position 77 to an intermediate position 78, shown in FIG. 10, and to an open position 79, shown in FIG. 11. Specifically, air flows in the direction of arrows 51 and 52 from a higher pressure location, such as interior space 32, toward a lower pressure location, such as intermediate space 33 or exterior space 34, forcing the flap 60 away from aperture 42 to the open position 79.

When air pressure inside the interior space 32 of the vehicle 20 is significantly higher than the air pressure at the exterior space 34 of the vehicle 20, such as when a hatch 30 is shut, the flap 60 is quickly moved from the closed position 77 to the open position 79 to allow a high flow rate of air through the aperture 42. When the air pressure inside the interior space 32 of the vehicle 20 is slightly higher than the air pressure at the exterior space 34 of the vehicle 20, such as when air conditioned or heated air is introduced into the interior space 32 of the vehicle 20, the flap 60 may be moved only to the intermediate position 78, i.e., slightly open, which is sufficient to allow air to exit the interior space 32 of the vehicle 20 in the direction of arrows 51 and 52. At the same time, the flap 60 covers much of the aperture 42, providing for noise damping of sound waves entering the intermediate space 33 from the exterior space 34 around the vehicle 20.

In other words, the noise damping flap 60 is configured to cover the aperture 42 in closed position 77, is movable to intermediate position 78 permitting a first rate of fluid flow through the aperture 42 when air pressure within the interior space 32 is at a first elevated level, and is movable to open position 79 permitting a second rate of fluid flow through the aperture 42 when air pressure within the interior space 32 is at a second elevated level greater than the first elevated level, wherein the second rate of fluid flow is greater than the first rate of fluid flow.

Flap 60 may be stiff such that movement of the flap 60 between the closed and open positions occurs by bending at the boundary 67 as shown. Alternatively, flap 60 may be flexible such that bending occurs along the length of the flap 60 rather than only at boundary 67.

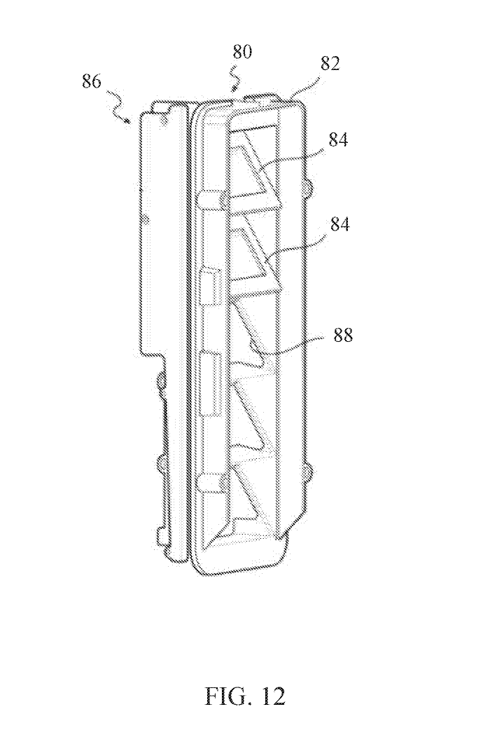

Referring back to FIG. 2, an exemplary valve 80 for selectively closing and opening fluid communication through aperture 48 is a pressure relief valve. FIG. 12 illustrates an exemplary pressure relief valve 80. As shown, an exemplary pressure relief valve 80 includes a housing 82, a plurality of vanes 84 pivotably attached to the housing 82, and an actuator mechanism 86 attached to the housing 82 and configured for moving the plurality of vanes 84 in unison between an open position and a closed position. The illustrated closed position prevents fluid communication between the intermediate space 33, shown in FIG.2, and the exterior space 34 around the vehicle 20, shown in FIGS. 1 and 2.

In FIG. 12, the housing 82 defines a plurality of openings 88. It should be appreciated that the housing 82 may include any number of openings 88, and that the plurality of vanes 84 will include a reciprocal number of vanes 84. It should also be appreciated that the openings 88 and the vanes 84 may be sized and/or configured other than shown to meet specific design requirements and packaging constraints.

One of the vanes 84 is disposed adjacent each of the openings 88. The vanes 84 are moveable between the open position and the closed position to open and close fluid communication through the openings 88. The pressure relief valve 80 includes a seal on at least one of the housing 82 and/or the vanes 84 to tightly seal the vanes 84 against the housing 82 when the vanes 84 are in the closed position. The seal may include and be manufactured from any suitable material capable of sealing between the vanes 84 and the housing 82 to prevent dirt, dust, water and noise from entering into the intermediate space 33 or interior space 32 of the vehicle 20 when the vanes 84 are in the closed position. It should also be appreciated that the seal may be configured in any suitable shape and configuration to meet the design requirements and constraints of the vehicle 20.

Each of the vanes 84 may pivot about axes relative to the housing 82. Each vane 84 may be coupled to the housing along a respective pivot axis. The vanes 84 may be pivotably coupled to the housing 82 in any suitable manner. An actuator mechanism 86 is coupled to at least one of the vanes 84 to move the vanes 84 between the open position and the closed position. A linkage may couple the vanes 84 so that all vanes 84 move in unison between the open and closed positions.

The housing 82 and the vanes 84 may include and be manufactured from any suitable material, such as a plastic material, a composite material, a metal material, or some other similar rigid material capable of maintaining their form during operation to ensure a tight seal between the vanes 84 and the housing 82.

In operation, the pressure relief valve 80 is attached to the vehicle 20, in or adjacent aperture 48 as described above. The normal position of the pressure relief valve 80 is the closed position, wherein all of the vanes 84 are sealed against the housing 82 to prevent fluid communication from the exterior space 34 to the interior space 32 and intermediate space 33. The sealing force of the vanes 84 and the housing 82 eliminate an influx of air, water, dirt, dust, or noise into the vehicle 20.

When an increase in air pressure within the interior space 32 of the vehicle 20 occurs, such as when a hatch 30 is closed or when air conditioned or heated air is directed into the interior space 32 of the vehicle 20, the pressure relief valve 80 is opened. As a result, noise from the exterior space 34 around the vehicle 20 may enter the intermediate space 33. The noise damping flap 60 reduces the noise that is introduced to the interior space 32 of the vehicle 20. Further, the noise damping flap 60 may automatically and passively move from the open position 79, or intermediate position 78, to the closed position 77 when airflow in the direction of arrows 51-53 is reduced. The noise damping flap 60 may be maintained in the intermediate position 78, which is a slightly opened position, when air pressure in the interior space 32 of the vehicle 20 is maintained at a slightly higher pressure than at the exterior space 34 of the vehicle 20, such as when a constant air conditioned or heated airflow into the interior space 32 of the vehicle 20 is maintained. As a result, while airflow in the direction of arrows 51-53 is permitted, the noise damping flap 60 largely restricts noise from entering the interior space 32 of the vehicle 20.

The flap is a simple and low cost noise damper or insulator that ensures noise absorption and a higher level of airflow as compared to conventional pressure relief valve designs. An exemplary flap design utilizes a die cut fiber (PET or other synthetic fiber) with an adhesive attached to the vehicle structure panel, typically sheet metal. The design works by allow airflow to lift the fiber flap when air is displaced towards the pressure relief valve. The low density material and resulting low weight flap allows a greater amount of airflow to pass through the aperture in the vehicle structural panel during times of peak elevated air pressure, such as during closure of a hatch, and the fiber flap returns to the closed position when there is no or little air pressure differential between the interior space and exterior space, i.e., no airflow out of the vehicle, providing noise insulation to the interior space of the vehicle.

While at least one exemplary aspect has been presented in the foregoing detailed description, it should be appreciated that a vast number of variations exist. It should also be appreciated that the exemplary aspect or exemplary aspects are only examples, and are not intended to limit the scope, applicability, or configuration of the claimed subject matter in any way. Rather, the foregoing detailed description will provide those skilled in the art with a convenient road map for implementing an exemplary aspect of the subject matter. It being understood that various changes may be made in the function and arrangement of elements described in an exemplary aspect without departing from the scope of the subject matter as set forth in the appended claims.

1. A vent assembly for opening and closing an interior space of a vehicle to permit air within the interior space of the vehicle to exit the interior space of the vehicle, the vent assembly comprising:
a structural panel bounding the interior space of the vehicle, the structural panel defining an aperture adapted to provide fluid communication between the interior space and a fluid path;
a single noise damping flap configured to cover the aperture in a closed position and movable to an open position permitting fluid flow through the aperture; and
a pressure relief valve located at an end of the fluid path and configured for selectively opening and closing fluid communication between the fluid path and an exterior environment outside the vehicle, wherein the fluid path is completely enclosed by the structural panel, the noise damping flap in the closed position, and the pressure relief valve when closed; wherein the vehicle is configured to introduce an airflow into the interior space to raise the air pressure within the interior space to a first level; wherein the noise damping flap is movable to an intermediate position permitting a first rate of fluid flow through the aperture when the air pressure within the interior space is at the first level; wherein air pressure within the interior space of the vehicle rises to a second level during a hatch closing; and wherein the noise damping flap permits a second rate of fluid flow greater than the first rate of fluid flow through the aperture when the air pressure within the interior space is at the second level.

2. The vent assembly of claim 1 wherein an end of the noise damping flap is adhered to a portion of the structural panel adjacent the aperture.

3. The vent assembly of claim 1 wherein an end of the noise damping flap includes an extended portion, and wherein the extended portion of the end of the noise damping flap is adhered to a portion of the structural panel adjacent the aperture.

4. The vent assembly of claim 1 wherein the noise damping flap has a top end and a bottom end, wherein the top end is mounted to the structural panel, wherein the bottom end contacts the structural panel in the closed position, and wherein the bottom end is raised to the open position.

5. The vent assembly of claim 1 wherein the noise damping flap is flexible.

6. The vent assembly of claim 1 wherein the noise damping flap is passively moved from the closed position to the open position by air flowing out of the interior space.

7. The vent assembly of claim 1 wherein the vent assembly consists of the structural panel, the aperture, the fluid path, the single noise damping flap, and the pressure relief valve.

8. A vent assembly for opening and closing an interior space of a vehicle to permit air within the interior space of the vehicle to exit the interior space of the vehicle, the vent assembly comprising:
a structural panel bounding the interior space of the vehicle, the structural panel defining one aperture adapted to provide fluid communication between the interior space and a fluid path; and
one noise damping flap configured to cover the aperture in a closed position, movable to an intermediate position permitting a first rate of fluid flow through the aperture when air pressure within the interior space is at a first level, and movable to an open position permitting a second rate of fluid flow through the aperture when the air pressure within the interior space is at a second level greater than the first level, wherein the second rate of fluid flow is greater than the first rate of fluid flow.

9. The vent assembly of claim 8 wherein an end of the noise damping flap is adhered to a portion of the structural panel adjacent the aperture.

10. The vent assembly of claim 8 wherein an end of the noise damping flap includes an extended portion, and wherein the extended portion of the end of the noise damping flap is adhered to a portion of the structural panel adjacent the aperture.

11. The vent assembly of claim 8 wherein the noise damping flap has a top end and a bottom end, wherein the top end is mounted to the structural panel, wherein the bottom end contacts the structural panel in the closed position, and wherein the bottom end is raised to the open position.

12. The vent assembly of claim 8 wherein the noise damping flap is flexible.

13. The vent assembly of claim 8 wherein the noise damping flap is passively moved between the closed position, the intermediate position, and the open position by air flowing out of the interior space.

14. The vent assembly of claim 8 wherein the noise damping flap comprises synthetic fibers.

15. A vehicle comprising:
an interior space bounding by structural panels and having an opening;
a hatch configured to close the opening;
an aperture configured to allow airflow to exit the interior space through a fluid path during closure of the hatch; and
a vent assembly for opening and closing the interior space of the vehicle to permit air within the interior space of the vehicle to exit the interior space of the vehicle, the vent assembly comprising:
a noise damping flap configured to cover the aperture in a closed position and movable to an open position permitting fluid flow through the aperture; and
a pressure relief valve located at an end of the fluid path and configured for selectively opening and closing fluid communication between the fluid path and an exterior environment outside the vehicle;
wherein the vehicle is configured to introduce an airflow into the interior space to raise the air pressure within the interior space to a first level; wherein the noise damping flap is movable to an intermediate position permitting a first rate of fluid flow through the aperture when the air pressure within the interior space is at the first level; wherein air pressure within the interior space of the vehicle rises to a second level during closure of the hatch; and wherein the noise damping flap permits a second rate of fluid flow greater than the first rate of fluid flow through the aperture when the air pressure within the interior space is at the second level.

16. (canceled)

17. (canceled)

18. The vehicle of claim 15 wherein the noise damping flap is passively moved between the closed position, the intermediate position, and the open position by air flowing out of the interior space.

19. The vehicle of claim 15 wherein the noise damping flap is passively moved from the closed position to the open position by air flowing out of the interior space.

20. The vehicle of claim 15 wherein the noise damping flap comprises synthetic fibers.

21. The vehicle of claim 15 wherein the noise damping flap completely covers the aperture in the closed position.

22. The vent assembly of claim 8 wherein the noise damping flap completely covers the aperture in the closed position.
